(19) United States
(12) Patent Application Publication
(10) Pub. No.: US 2005/0260456 A1
(43) Pub. Date: Nov. 24, 2005

(54) Magnetic recording medium

(75) Inventors: Kazuko Hanai, Kanagawa (JP); Ayako Matsumoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/132,405

(22) Filed: May 19, 2005

(30) Foreign Application Priority Data
May 19, 2004 (JP) P.2004-148754

(51) Int. Cl. G11B 5/716

(52) U.S. Cl. 428/840.1; 428/847.2; 428/847.7

(57) ABSTRACT

A magnetic recording medium comprising: a nonmagnetic support; and a magnetic layer containing ferromagnetic powder and a binder, wherein the nonmagnetic support contains polyester, the nonmagnetic support has gauche/trans peak intensity ratio of 0.50 or less as determined by a ATR-FT-IR method, and a shrinkage percentage of the magnetic recording medium after storage for 1 week under a conditions of 70° C. and 5% RH is 0.040% or less.

### FIELD OF THE INVENTION

The present invention relates to a magnetic recording medium. More specifically, the present invention relates to a magnetic recording medium remarkably enhanced in the durability, storability and high-density recording properties with improved thermal shrinkage percentage and suppressed curl (warp).

### BACKGROUND OF THE INVENTION

In the field of magnetic disc, a 2 MB MF-2HD floppy disc using a Co-modified iron oxide is being normally mounted in personal computers. However, with the today's abrupt increase in the volume of data handled, the capacity of such a disc becomes inadequate and a high-capacity floppy disc is demanded.

In particular, coupled with the reduction in the size of computer and the increase in the information processing capability, a large recording capacity and a high data transfer speed are strongly demanded so as to achieve high-capacity recording and size reduction.

In conventional magnetic recording mediums in wide use, a magnetic layer comprising iron oxide, Co-modified iron oxide, CrO₂, ferromagnetic metal powder or hexagonal ferrite powder dispersed in a binder is coated on a nonmagnetic support. Among these magnetic powders, ferromagnetic metal fine powder and hexagonal ferrite powder are known to afford good high-density recording properties.

In the case of a disc, for example, 10 MB MF-2TD and 21 MB MF-2SD are known as a high-capacity disc using ferromagnetic metal powder excellent in the high-density recording properties, and 4 MB MF-2ED and 21 MB floptical are known as a high-capacity disc using hexagonal ferrite, but these magnetic discs are not satisfied in view of capacity and performance. Under these circumstances, many attempts are being made to enhance the high-density recording properties. Examples thereof are described below.

In order to enhance the properties of a disc-like magnetic recording medium, JP-A-64-84418 (the term “JP-A” as used herein means an “unexamined published Japanese patent application”) proposes to use a vinyl chloride resin having an acidic group, an epoxy group and a hydroxyl group; JP-B-3-12374 (the term “JP-B” as used herein means an “examined Japanese patent publication”) proposes to use a metal fine powder having Hc of 79,600 A/m (1,000 Oe) or more and a specific surface area of 25 to 70 m²/g; and JP-B-6-28106 proposes to specify the specific surface area and the magnetization amount of the magnetic material and incorporate an abrasive.

In order to improve the durability of a disc-like magnetic recording medium, JP-B-7-85304 proposes to use an unsaturated fatty acid ester and a fatty acid ester having an ether bond; JP-B-7-70045 proposes to use a branched fatty acid ester and a fatty acid ester having an ether bond; JP-A-54-124716 proposes to incorporate nonmagnetic powder having a Mohs' hardness of 6 or more and a higher fatty acid ester; JP-B-7-89407 proposes to specify the volume and surface roughness (0.005 to 0.025 μm) of lubricant-containing pores; JP-A-61-294637 proposes to use a low melting point fatty acid ester and a high melting point fatty acid ester; JP-B-7-36216 proposes to use an abrasive having a particle diameter of ¼ to ¾ with respect to the thickness of the magnetic layer and a low melting point fatty acid ester; and JP-A-3-203018 proposes to use an Al-containing metal magnetic material and a chromium oxide.

As for the construction of a disc-like magnetic recording medium having a nonmagnetic lower or intermediate layer, JP-A-3-120613 proposes a construction having an electrically conducting layer and a magnetic layer containing a metal fine powder; JP-A-6-290446 proposes a construction having a magnetic layer of 1 μm or less and a nonmagnetic layer; JP-A-62-159337 proposes a construction comprising a carbon intermediate layer and a lubricant-containing magnetic layer; JP-A-5-290358 proposes a construction having a nonmagnetic layer in which the carbon size is specified; and JP-A-8-249649 proposes to specify the amount of voids in each of the lower coated layer and the upper magnetic layer and provide a liquid lubricant reservoir.

In recent years, a disc-like magnetic recording medium comprising a thin magnetic layer and a functional nonmagnetic layer has been developed, and 100 MB-class floppy discs are making debut. As for the characteristic features thereof, JP-A-5-109061 proposes a construction comprising a magnetic layer with Hc of 111,440 A/m (1,400 Oe) or more and a thickness of 0.5 μm or less and a nonmagnetic layer containing an electrically conducting particle; JP-A-5-197946 proposes a construction comprising an abrasive larger than the thickness of the magnetic layer; JP-A-5-290354 proposes a construction in which the thickness of the magnetic layer is 0.5 μm or less, the fluctuation in the thickness of the magnetic layer is within ±15% and the surface electric resistance is specified; and JP-A-6-68453 proposes a construction in which two abrasives differing in the particle diameter are incorporated and the amount of the abrasive on the surface is specified. Also, in multiple running operations of the disc by repeatedly using it at a high speed, the demand for, for example, the reliability of performances such as stable recording and reading of data is stronger than ever before. JP-A-6-52541 discloses a magnetic recording medium in which at least one powder of alumina, chromium oxide and diamond is added as an abrasive, and reports that good running stability is achieved by the addition of such a high-hardness powder.

In these large-capacity magnetic disc mediums, the linear recording density and track density are increased and the area per bit of the signal sharply decreases. Therefore, even a slight warp on the disc comes to be a fatal defect in recording and reproducing signals. That is, even a fine curl causing no problem at a conventional number of revolutions of the magnetic medium gives rise to mis-tracking and this occurs more often as the density is higher. Also, the storability of the magnetic recording medium is important. Particularly, in a high-density magnetic recording medium, if fine shrinkage in the medium plane direction is present after storage at a high temperature, tracking failure readily occurs similarly to the curl and it is also important to suppress the shrinkage during storage.

### SUMMARY OF THE INVENTION

An object of the present invention is to provide a magnetic recording medium remarkably enhanced in the durability, storability and high-density recording properties with improved thermal shrinkage percentage and suppressed curl (warp).

The present invention is as follows.

(1) A magnetic recording medium comprising a nonmagnetic support having provided thereon a magnetic layer comprising ferromagnetic powder dispersed in a binder, wherein the nonmagnetic support is a polyester support, the gauche/trans peak intensity ratio of the polyester support is 0.50 or less as determined by the ATR-FT-IR method, and the shrinkage percentage of the magnetic recording medium after storage for 1 week under the conditions of 70° C. and 5% RH is 0.040% or less.

(2) The.magnetic recording medium as described in (1) above, wherein a substantially nonmagnetic lower layer and a magnetic layer comprising ferromagnetic powder dispersed in a binder are provided in this order on the nonmagnetic support.

(3) The magnetic recording medium as described in (1) or (2) above, wherein the polyester support is a polyethylene naphthalate-made support.

As a result of intensive investigations to attain the above-described object, the present inventors have found that when a fine curl is present in a magnetic recording medium such as floppy disc, tracking does not smoothly proceed in the outer circumferential part and this causes characteristic deterioration. The present inventors have further studied in detail the polyester-made support surface of magnetic recording mediums by the ART-FT-IR method, as a result, it has been found that in the polyester allowing for no occurrence of curling, the gauche/trans peak intensity ratio as an index for crystallization is small as compared with the polyester in which a curl is generated.

More specifically, the crystal/amorphous degree of polyester is affected by the heat history or stretching in the process. The amorphous moiety is in a non-equilibrium state with excess volume and when heat at a temperature lower than the glass transition point is applied, volume shrinkage occurs and the density increases. Therefore, if the proportion of the amorphous moiety is large, there arises a problem in the dimensional stability. However, by decreasing the gauche/trans peak intensity ratio, that is, elevating the crystallization degree of polyester, the strength can be increased and the amorphous moiety can be relatively decreased, so that the problem of curl can be overcome. Furthermore, according to the present invention, the thermal shrinkage percentage is set to be a low value, so that a magnetic recording medium remarkably enhanced in the durability, storability and high-density recording properties can be provided.

### DETAILED DESCRIPTION OF THE INVENTION

The present invention is described in detail below.

[Nonmagnetic Support]

The polyester support (hereinafter simply referred to as “polyester”) used as the nonmagnetic support of the present invention is a polyester comprising a dicarboxylic acid and a diol, such as polyethylene terephthalate and polyethylene naphthalate.

Examples of the dicarboxylic acid component as main constituent component include terephthalic acid, isophthalic acid, phthalic acid, 2,6-naphthalenedicarboxylic acid, 2,7-naphthalenedicarboxylic acid, diphenylsulfone-dicarboxylic acid, diphenyletherdicarboxylic acid, diphenylethanedicarboxylic acid, cyclohexanedicarboxylic acid, diphenyldicarboxylic acid, diphenylthioetherdicarboxylic acid, diphenylketonedicarboxylic acid and phenylindanedicarboxylic acid.

Examples of the diol component include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorenedihydroxyethyl ether, diethylene glycol, neopentyl glycol, hydroquinone and cyclohexanediol.

Among polyesters comprising these main constituent components, in view of transparency, mechanical strength, dimensional stability and the like, preferred are polyesters where the main constituent components are terephthalic acid and/or 2,6-naphthalenedicarboxylic acid as the dicarboxylic acid component, and ethylene glycol and/or 1,4-cyclohexanedimethanol as the diol component.

In particular, the polyester is preferably a polyester comprising polyethylene terephthalate or polyethylene-2,6-naphthalate as a main constituent component, a copolymerized polyester comprising terephthalic acid, 2,6-naphthalenedicarboxylic acid and ethylene glycol, or a polyester comprising a mixture of two or more of these polyesters as a main constituent component, more preferably a polyester comprising polyethylene-2,6-naphthalate as a main constituent component.

The polyester for use in the present invention may be biaxially stretched or may be a laminate body of two or more layers.

In the polyester, another copolymerization component may be further copolymerized or another polyester may be mixed, as long as the effects of the present invention are not impaired.

In order to less cause delamination when formed into a film, the polyester for use in the present invention may be copolymerized with a sulfonate group-containing aromatic dicarboxylic acid or an ester-forming derivative thereof, a polyoxyalkylene group-containing dicarboxylic acid or an ester-forming derivative thereof, or a polyoxyalkylene group-containing diol.

Particularly, in view of polymerization reactivity of the polyester and transparency of the film, the compound to be copolymerized is preferably, for example, a 5-sodium sulfoisophthalic acid, a 2-sodium sulfoterephthalic acid, a 4-sodium sulfophthalic acid, a 4-sodium sulfo-2,6-phthalenedicarboxylic acid, a compound resulting from replacing the sodium in these compounds with another metal (e.g., potassium, lithium), ammonium salt or sulfonium salt or an ester-forming derivative thereof, a polyethylene glycol, a polytetramethylene glycol, a polyethylene glycol-polypropylene glycol copolymer, or a compound resulting from converting hydroxy groups at both ends in these compounds into carboxyl groups through oxidization or the like. The proportion of the compound copolymerized to this purpose is preferably from 0.1 to 10 mol % based on the dicarboxylic acid constituting the polyester.

Furthermore, for the purpose of enhancing the heat resistance, a bisphenol-based compound or a compound having a naphthalene or cyclohexane ring can be copolymerized. The proportion of such a compound in the copolymerization is preferably from 1 to 20 mol % based on the dicarboxylic acid constituting the polyester.

In the present invention, the polyester is not particularly limited in its synthesis method and can be produced by a conventionally known production process. Examples of the production process which be used include a direct esterification process of directly esterifying a dicarboxylic acid component with a diol component, and a transesterification process of first performing a transesterification reaction of a dialkyl ester used as the dicarboxylic acid component with a diol component, and then heating the reaction product under reduced pressure to remove the excess diol component, thereby performing the polymerization. At this time, if desired, a transesterification or polymerization reaction catalyst may be used or a heat-resistant stabilizer may be added.

Also, various additives may be added individually or in combination of two or more thereof in each step at the synthesis, such as coloration inhibitor, antioxidant, crystal nucleus agent, slipping agent, stabilizer, antiblocking agent, ultraviolet absorbent, viscosity adjusting agent, defoaming transparency agent, antistatic agent, pH adjusting agent, dye, pigment and reaction stopping agent.

The polyester used as the support in the present invention satisfies the condition that the gauche/trans peak intensity ratio (all of a peak intensity ratio of gauche/trans on the front surface in the machine direction, a peak intensity ratio of gauche/trans on the front surface in the transverse direction, a peak intensity ratio of gauche/trans on the back surface in the machine direction and a peak intensity ratio of gauche/trans on the back surface in the transverse direction) as an index for crystallization is 0.50 or less as determined by the ATR-FT-IR method. If this peak intensity ratio exceeds, the curling cannot be inhibited.

The gauche/trans peak intensity ratio according to the ATR-FT-IR method may be determined by measuring the gauche structure and trans structure produced by the internal rotation centering on the carbon-carbon bond of a glycol unit in a usual manner. For example, when a polyethylene naphthalate is used as the polyester, the measurement is performed by using Nexus 670 (trade name, manufactured by Thermo-Nicolet) with a reflection ATR accessory at a resolution of 1 cm⁻¹ through integration of 200 times. The ratio of the absorbance of γω (CH₂) gauche peak at 1,370 cm⁻¹ to the absorbance of γω (CH₂) trans peak at 1,337 cm⁻¹ may be determined as an index for crystallization degree.

The gauche/trans peak intensity ratio as an index for crystallization determined by the ATR-FR-IR method can be made to be 0.50 or less by appropriately setting the heat history or stretching conditions at the production of the polyester. For example, when a polyethylene naphthalate is used as the polyester, the peak intensity ratio may be set by causing the temperature after stretching to drop as slow as possible and thereby effecting the crystallization in the case of setting the peak intensity ratio by the change of heat history, and by performing the stretching at a large draw ratio to effect the crystallization through orientation in the case of setting the peak intensity ratio by the change of stretching conditions.

More specifically, for example, the polyester is extruded into a sheet from a mouthpiece at a temperature of the melting point (Tm) to Tm+70° C. by using a known extruder, and then quench-solidified at 40 to 90° C. to obtain an unstretched laminate film. Thereafter, this unstretched film is stretched by a normal method in one axial direction at a temperature in the vicinity of (glass transition temperature (Tg)−10) to (Tg+70)° C. at a draw ratio of 2.5 to 4.5 times, preferably from 2.8 to 3.9 times, then stretched in the direction perpendicular to the above stretching direction at a temperature in the vicinity of Tg to (Tg+70)° C. at a draw ratio of 4.5 to 8.0 times, preferably from 4.5 to 6.0 times, and, if desired, again stretched in the longitudinal direction and/or the transverse direction to obtain a biaxially oriented film. That is, stretching may be performed through two stages, three stages, four stages or multiple stages. The total draw ratio is usually 12 times or more, preferably from 12 to 32 times, more preferably from 14 to 26 times, in terms of an area draw ratio. Furthermore, the biaxially oriented film is preferably heat set and thereby crystallized at a temperature of (Tg+70) to (Tm−10)° C., for example, from 180 to 250° C. The heat setting time is preferably 1 to 60 seconds.

Also, a filler may be added to the polyester. Examples of the filler include an inorganic powder such as spherical silica, colloidal silica, titanium oxide and alumina, and an organic filler such as crosslinked polystyrene and silicone resin.

In the present invention, the thickness of the polyester as the support is preferably from 10 to 100 μm, more preferably from 20 to 80 μm. The center line average roughness (Ra) on the support surface is 8 nm or less, preferably 6 nm or less. This Ra was measured by TOPO-3D manufactured by WYKO.

In the magnetic recording medium of the present invention, a magnetic layer comprising ferromagnetic powder dispersed in a binder is provided in the above-described nonmagnetic support, and, if desired, a nonmagnetic layer (lower layer) which is substantially nonmagnetic may be provided between the support and the magnetic layer. The components of each layer constituting the magnetic recording medium, the layer structure, the specific method for producing the magnetic recording medium, and the like are described below one by one.

[Magnetic Layer]

The ferromagnetic powder contained in the magnetic layer preferably has a volume of (0.1 to 8)×10⁻¹⁸ ml, more preferably (0.5 to 5)×10⁻¹⁸ ml. With a volume in this range, the magnetic properties can be effectively prevented from reduction due to thermal fluctuation and at the same time, good C/N (S/N) can be obtained while maintaining low noise. The ferromagnetic powder is preferably a ferromagnetic metal powder or a hexagonal ferrite powder.

The volume of the ferromagnetic powder can be determined as follows.

In the case of a ferromagnetic metal powder, assuming that the shape is a cylinder, the volume is determined from the long axis length and the short axis length. In the case of a hexagonal ferrite powder, assuming that the shape is a hexagonal cylinder, the volume is determined from the plate diameter and the axis length (plate thickness).

The size of the ferromagnetic powder is determined as follows. An appropriate amount of the magnetic layer is stripped off. Then, n-butylamine is added to 30 to 70 mg of the stripped magnetic layer and the resulting mixture is enclosed in a glass tube. The glass tube is set in a thermal decomposition apparatus and heated at 140° C. for about 1 day. After cooling, the content is taken out from the glass tube and separated into a liquid and a solid content by centrifugation. The separated solid content is washed with acetone to obtain a powder sample for TEM. The particles of this sample are photographed by Hitachi Transmission Electron Microscope Model H-9000 at a magnification of 100,000 and then, the photograph is printed on a printing paper to a total magnification of 500,000, whereby a particle photograph is obtained. An objective magnetic material is selected on the particle photograph and after placing it on an image analyzer KS-400 Digitizer manufactured by Kontron, the contour of the powder is traced and the size of each particle is measured. The size is measured on 500 particles and the measured values are averaged to determine the average particle diameter.

<Ferromagnetic Metal Powder>

The ferromagnetic metal powder for use in the magnetic layer of the magnetic recording medium of the present invention is not particularly limited as long as the metal (including an alloy) mainly comprises Fe, but a ferromagnetic alloy powder mainly comprising α-Fe is preferred. In addition to the prescribed atoms, the ferromagnetic metal powder may contain atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B. Those containing, in addition to α-Fe, at least one of Al, Si, Ca, Y, La, Nd, Co, Ni and B are preferred. In particular, Co, Al and Y are preferred. More specifically, the content based on Fe is preferably from 10 to 40 atomic % of Co, from 2 to 20 atomic % of Al and from 1 to 15 atomic % of Y.

The ferromagnetic metal powder may be previously treated with a dispersant, a lubricant, a surfactant, an antistatic agent or the like before dispersion. Furthermore, the ferromagnetic metal powder may contain a small amount of water, hydroxide or oxide. The moisture content of the ferromagnetic metal powder is preferably from 0.01 to 2%. The moisture content of the ferromagnetic metal powder is preferably optimized according to the kind of the binder. The pH of the ferromagnetic metal powder is preferably optimized according to the combination with a binder used. The pH range is usually 6 to 12, preferably from 7 to 11. The ferromagnetic powder sometimes contains a soluble inorganic ion such as Na, Ca, Fe, Ni, Sr, NH₄, SO₄, Cl, NO₂ and NO₃, but preferably contains substantially no such ion. When the sum total of these ions is about 300 ppm or less, the properties are not affected. Furthermore, the ferromagnetic powder for use in the present invention preferably contains less pores, and the pore content is preferably 20 vol % or less, more preferably 5 vol % or less.

The crystallite size of the ferromagnetic metal powder is preferably from 8 to 20 nm, more preferably from 10 to 18 nm, still more preferably from 12 to 16 nm. The crystallite size is an average value determined by the Scherrer method from the half width of the diffraction peak with use of an X-ray diffraction apparatus (RINT 2000 Series, manufactured by Rigaku Corporation) under conditions that the radiation source is CuKα1, the tube voltage is 50 kV and the tube current is 300 mA.

The specific surface area (S_{BET}) of the ferromagnetic metal powder by the BET method is preferably from 30 m²/g to less than 50 m²/g, more preferably from 38 to 48 m²/g. Within this range, both good surface properties and low noise can be realized. The pH of the ferromagnetic metal powder is preferably optimized according to the combination with the binder used. The pH range is from 4 to 12, preferably from 7 to 10. If desired, the ferromagnetic metal powder may be surface-treated with Al, Si, P, an oxide thereof or the like. The amount thereof is from 0.1 to 10% based on the ferromagnetic metal powder. When a surface treatment is applied, the adsorption of a lubricant such as fatty acid is suppressed to 100 mg/m² or less and this is preferred. The ferromagnetic metal powder sometimes contains a soluble inorganic ion such as Na, Ca, Fe, Ni and Sr, but when the content thereof is 200 ppm or less, such ion little affects the properties. Furthermore, the ferromagnetic metal powder for use in the present invention preferably contains less pores, and the pore content is preferably 20 vol % or less, more preferably 5 vol % or less.

The ferromagnetic metal powder may be have any shape of needle, grain, pebble and plate as long as the above-described particle volume is satisfied. In particular, a needle-like ferromagnetic powder is preferred. In the case of a needle-like ferromagnetic metal powder, the acicular ratio is preferably from 4 to 12, more preferably from 5 to 12. The coercive force (Hc) of the ferromagnetic metal powder is preferably from 159.2 to 238.8 kA/m (from 2,000 to 3,000 Oe), more preferably from 167.2 to 230.8 kA/m (from 2,100 to 2,900 Oe). The saturation magnetic flux density is preferably from 150 to 300 mT (from 1,500 to 3,000 G), more preferably from 160 to 290 mT, The saturation magnetization (σs) is preferably from 140 to 170 A·m²/kg (from 140 to 170 emu/g), more preferably from 145 to 160 A·m²/kg. The SFD (switching field distribution) of the magnetic material itself is preferably smaller and is preferably 0.8 or less. When the SFD is 0.8 or less, good electromagnetic conversion properties, high output, sharp magnetization reversal and small peak shift are obtained and this is advantageous to high-density digital magnetic recording. Examples of the method for achieving a small He distribution include a method of improving the particle size distribution of goethite in the ferromagnetic metal powder, a method of using monodisperse αF₂O₃, and a method of preventing sintering of particles.

The ferromagnetic metal powder may be a ferromagnetic metal powder obtained by a known production method, and examples of the method include a method where an iron oxide or hydrous iron oxide treated to prevent sintering is reduced with a reducing gas such as hydrogen to obtain Fe or Fe—Co particles; a method where a composite organic acid salt (mainly oxalate) is reduced with a reducing gas such as hydrogen; a method where a metal carbonyl compound is thermally decomposed; a method where a reducing agent such as sodium boron hydride, hypophosphite or hydrazine is added to an aqueous solution of a ferromagnetic metal, thereby effecting the reduction; and a method where a metal is evaporated in a low-pressure inert gas to obtain a powder. The ferromagnetic metal powder thus obtained is subjected to a known slow oxidation treatment. A method of reducing a hydrous iron oxide or an iron oxide with a reducing gas such as hydrogen, and forming an oxide film on the surface by controlling the partial pressures of oxygen-containing gas and inert gas, temperature and time is preferred because of less demagnetization.

<Ferromagnetic Hexagonal Ferrite Powder>

Examples of the ferromagnetic hexagonal ferrite powder include barium ferrite, strontium ferrite, lead ferrite, calcium ferrite and substitution (e.g., Co substitution) products thereof. Specific examples thereof include magnetoplumbite-type barium ferrite and strontium ferrite; magnetoplumbite-type ferrite in which the particle surface is covered with spinel; and magnetoplumbite-type barium ferrite and strontium ferrite, in which a spinel phase is partially contained. The hexagonal ferrite powder may contain, in addition to the prescribed atoms, atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb. In general, those containing Co—Zn, Co—Ti, Co—Ti—Zr, Co—Ti—Zn, Ni—Ti—Zn, Nb—Zn—Co, Sb—Zn—Co or Nb—Zn may be used. Depending on the raw materials and production process, some may contain specific impurities.

The particle size of the ferromagnetic hexagonal ferrite powder is a size satisfying the above-described volume, and the average plate ratio {average of (plate diameter/plate thickness)} is preferably from 1 to 15, more preferably from 1 to 7. When the plate ratio is from 1 to 15, satisfactory orientation property can be obtained while maintaining a high filling property in the magnetic layer and at the same time, increase of noise due to stacking of particles can be suppressed. The specific surface area by BET method within the above-described particle size is from 10 to 200 m²/g. This specific surface area nearly corresponds to an arithmetic value from the particle plate diameter and the plate thickness.

The particle plate diameter and plate thickness of the ferromagnetic hexagonal ferrite powder preferably have a narrower distribution. The numerical values of the particle plate diameter and plate thickness can be compared by randomly measuring 500 particles on a TEM photograph of particles. The distributions of particle plate diameter and plate thickness are not a regular distribution in many cases, but when calculated and expressed as the standard deviation to the average size, σ/average size is from 0.1 to 2.0. In order to achieve a sharp particle size distribution, the particle producing reaction system is made as uniform as possible and the particles produced are subjected to a distribution-enhancing treatment. For example, a method of selectively dissolving ultrafine particles in an acid solution is also known.

The coercive force (Hc) of the hexagonal ferrite particle may be from 159.2 to 238.8 kA/m (from 2,000 to 3,000 Oe) but is preferably from 175.1 to 222.9 kA/m (from 2,200 to 2,800 Oe), more preferably from 183.1 to 214.9 kA/m (From 2,300 to 2,700 Oe). However, when the saturation magnetization (σs) of the head exceeds 1.4 T, the coercive force is preferably 159.2 kA/m or less. The coercive force (Hc) can be controlled by the particle size (plate diameter, plate thickness), the kinds and amounts of elements contained, the substitution sites of elements, the particle producing reaction conditions and the like.

The saturation magnetization (σs) of the hexagonal ferrite particle is from 40 to 80 A·m²/kg (emu/g). The saturation magnetization (σs) is preferably higher, but as the particle becomes smaller, the saturation magnetization tends to decrease, For improving the saturation magnetization (σs), it is well known, for example, to compound a spinel ferrite with a magnetoplumbite ferrite or select the kinds and amounts of elements contained. Use of W-type hexagonal ferrite is also possible. In dispersing the magnetic material, the surface of the magnetic material particle may also be treated with a substance suited to the dispersion medium and the polymer. As for the surface-treating agent, both an organic compound and an inorganic compound can be used. Representative examples of the main compound include oxides and hydroxides of Si, Al, P and the like, various silane coupling agents, and various titanium coupling-agents. The amount added of the surface-treating agent is from 0.1 to 10 mass % (weight %) based on the mass of the magnetic material. The pH of the magnetic material is also important for the dispersion. An optimum value depending on the dispersion medium and polymer is usually in the range of approximately from 4 to 12, but in view of chemical stability and storability of the medium, a pH of about 6 to 11 is selected. The water content in the magnetic material also affects the dispersion. The optimum value is selected depending on the dispersion medium and polymer but a water content of 0.01 to 2.0% is usually selected.

Examples of the method for producing the ferromagnetic hexagonal ferrite powder include (1) a vitrified crystallization method where barium oxide, iron oxide and a metal oxide for substituting iron are mixed with a glass forming substance such as boron oxide to give a desired ferrite composition, the mixture is melted and quenched to form an amorphous material, the amorphous material is again heat-treated, and the product is washed and ground to obtain a barium ferrite crystal powder; (2) a hydrothermal reaction method where a barium ferrite composition metal salt solution is neutralized with an alkali, the by-product is removed, the residue in a liquid phase is heated at 100° C. or more, and the product is washed, dried and ground to obtain a barium ferrite crystal powder; and (3) a coprecipitation method where a barium ferrite composition metal salt solution is neutralized with an alkali, the by-product is removed, and the residue is dried, treated at 1,100° C. or less and ground to obtain a barium ferrite crystal powder. However, any production method can be used in the present invention. The ferromagnetic hexagonal ferrite powder may be surface-treated, if desired, with Al, Si, P, an oxide thereof or the like. The amount thereof is preferably from 0.1 to 10% based on the ferromagnetic powder and when a surface treatment is applied, the adsorption of a lubricant such as fatty acid is suppressed to 100 mg/m² or less and this is preferred. The ferromagnetic powder sometimes contains a soluble inorganic ion such as Na, Ca, Fe, Ni and Sr. The ferromagnetic powder preferably contains substantially no such ion but when the content thereof is 200 ppm or less, the ion little affects the properties.

<Binder>

The binder for use in the magnetic layer of the present invention is a conventionally known thermoplastic resin, thermosetting resin or reactive resin, or a mixture thereof. Examples of the thermoplastic resin include polymers and copolymers containing, as a constituent unit, vinyl chloride, vinyl acetate, vinyl alcohol, maleic acid, acrylic acid, acrylic acid ester, vinylidene chloride, acrylonitrile, methacrylic acid, methacrylic acid ester, styrene, butadiene, ethylene, vinyl butyral, vinyl acetal or vinyl ether, polyurethane resins and various rubber-based resins.

Examples of the thermosetting resin and reactive resin include a phenol resin, an epoxy resin, a polyurethane curable resin, a urea resin, a melamine resin, an alkyd resin, an acrylic reactive resin, a formaldehyde resin, a silicone resin, an epoxy-polyamide resin, a mixture of polyester resin and isocyanate prepolymer, a mixture of polyester polyol and polyisocyanate, and a mixture of polyurethane and polyisocyanate. The thermoplastic resin, thermosetting resin and reactive resin are described in detail in Plastic Handbook, Asakura Shoten.

Furthermore, when an electron beam-curable resin is used in the magnetic layer, not only coating film strength is improved to enhance the durability but also the surface is rendered smooth to more enhance the electromagnetic conversion properties. Examples of such a resin and the production method therefor are described in detail in JP-A-62-256219.

These resins can be used individually or in combination. Among these, preferred is a polyurethane resin, more preferred are a polyurethane resin which is obtained by reacting a cyclic structure such as hydrogenated bisphenol A or polypropylene oxide adduct of hydrogenated bisphenol A, a polyol having an alkylene oxide chain and a molecular weight of 500 to 5,000, a polyol as a chain-extending agent having a cyclic structure and a molecular weight of 200 to 500, and an organic diisocyanate, and in which a polar group is introduced; a polyurethane resin which is obtained by reacting an aliphatic dibasic acid such as succinic acid, adipic acid or sebacic acid, a polyester polyol comprising an aliphatic diol having an alkyl branched side chain and not having a cyclic structure, such as 2,2-dimethyl-1,3-propanediol, 2-ethyl-2-butyl-1,3-propanediol or 2,2-diethyl-1,3-propanediol, an aliphatic diol as a chain-extending agent having a branched alkyl side chain containing 3 or more carbon atoms, such as 2-ethyl-2-butyl-1,3-propanediol or 2,2-diethyl-1,3-propane-diol, and an organic diisocyanate, and in which a polar group is introduced; and a polyurethane resin which is obtained by reacting a cyclic structure such as dimer diol, a polyol compound having a long alkyl chain, and an organic diisocyanate, and in which a polar group is introduced.

The average molecular weight of the polar group-containing polyurethane resin for use in the present invention is preferably from 5,000 to 100,000, more preferably from 10,000 to 50,000. When the average molecular weight is 5,000 more, this advantageously causes neither reduction in the physical strength of the obtained magnetic coating film, such as embrittlement, nor adverse effect on the durability of the magnetic recording medium Also, when the molecular weight is 100,000 ore less, the solubility in a solvent does not decrease and in turn good dispersion is obtained. Furthermore, the viscosity of the coating material at a predetermined concentration is not elevated and therefore, good workability and easy handle-ability are ensured.

Examples of the polar group contained in the polyurethane resin include —COOM, —SO₃M, —OSO₃M, —P|O(OM)₂, —O—P═O(OM)₂ (wherein M is a hydrogen atom or an alkali metal base), —OH, —NR₂, —N⁺R₃ (wherein R is a hydrocarbon group), an epoxy group, —SH and —CN. At least one of these polar groups may be incorporated by copolymerization or addition reaction. When the polar group-containing polyurethane resin has an OH group, the OH group is preferably a branched OH group in view of curability and durability. The polyurethane resin preferably has from 2 to 40 branched OH groups, more preferably from 3 to 20 branched OH groups, per molecule. The amount of such a polar group is from 10⁻¹ to 10⁻⁹ mol/g, preferably from 10⁻² to 10−6 mol/g.

Specific examples of the binder include VAGH, VYHH, VMCH, VAGF, VAGD, VROH, VYES, VYNC, VMCC, XYHL, XYSG, PKHH, PKHJ, PKHC and PKFE produced by Union Carbide Corporation; MPR-TA, MPR-TA5, MPR-TAL, MPR-TSN, MPR-TMF, MPR-TS, MPR-TM and MPR-TAO produced by Nissin Chemical Industry Co., Ltd.; 1000W, DX80, DX81, DX82, DX83 and 100FD produced by Electro Chemical Industry Co., Ltd.; MR-104, MR-105, MR110, MR100, MR555 and 400X-110A produced by Nippon Zeon Co., Ltd.; Nippollan N2301, N2302 and N2304 produced by Nippon Polyurethane Industry Co., Ltd.; Pandex T-5105, T-R3080, T-5201, Burnock D-400, D-210-80, Crisvon 6109 and 7209 produced by Dai-Nippon Ink & Chemicals, Inc.; Vylon UR8200, UR8300, UR-8700, RV530 and RV280 from Toyobo Co., Ltd.; Daipheramine 4020, 5020, 5100, 5300, 9020, 9022 and 7020 produced by Dainichiseika Color & Chemicals Mfg. Co., Ltd.; MX5004 produced by Mitsubishi Chemical Corporation; Sanprene SP-150 produced by Sanyo Chemical Industries, Ltd.; and Saran F310 and P210 produced by Asahi Kasei Chemicals Corporation.

The amount added of the binder for use in the magnetic layer of the present invention is from 5 to 50 mass %, preferably from 10 to 30 mass %, based on the mass of the ferromagnetic metal powder. In the case of using a polyurethane resin, from 2 to 20 mass % of polyurethane resin and from 2 to 20 mass % of polyisocyanate are preferably used in combination. However, for example, when corrosion of the head occurs due to trace chlorine released, only polyurethane or only polyurethane and isocyanate may be used. In the case of using a vinyl chloride resin as another resin, this resin is preferably used in the range from 5 to 30 mass %. In the present invention, when polyurethane is used, the glass transition temperature is preferably from −50 to 150° C., more preferably from 0 to 100° C., the elongation at break is preferably from 100 to 2,000%, the stress at break is preferably from 0,49 to 98 MPa (from 0.05 to 10 kg/mm²), and the yield point is preferably from 0.49 to 98 MPa (from 0.05 to 10 kg/mm²).

When the magnetic recording medium of the present invention is, for example, a floppy disc, the magnetic recording medium may comprise two or more layers on both surfaces of the support. Accordingly, the amount of the binder, the amounts of the vinyl chloride resin, poly-urethane resin, polyisocyanate and other resins contained in the binder, the molecular weight of each resin constituting the magnetic layer, the amount of the polar group, or the above-described physical properties of the resins can be of course varied in the nonmagnetic layer and each magnetic layer as needed. These factors should be rather optimized in respective layers, and known techniques for multilayer magnetic layers can be applied, For example, when the amount of the binder is varied in respective layers, it is effective for reducing scratches on the magnetic layer surface to increase the amount of the binder in the magnetic layer. Also, for obtaining good head touch against the head, the amount of the binder in the nonmagnetic layer may be increased to impart flexibility.

Examples of the polyisocyanate usable in the present invention include isocyanates such-as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; reaction products of these isocoyanates with polyalcohol; and polyisocyanates produced by the condensation of isocyanates. These polyisocyanates are commercially available under the trade names of Coronate L, Coronate HL, Coronate 2030, Coronate 2031, Millionate MR and Millionate MTL produced by Nippon Polyurethane Industry Co., Ltd.; Takenate D-102, Takenate D-110N, Takenate D-200 and Takenate D-202 produced by Takeda Chemical Industries, Ltd.; and Desmodur L, Desmodur IL, Desmodur N and Desmodur HL produced by Sumitomo Bayer Co., Ltd. In each layer, these poly-isocyanates may be used individually or in combination of two or more thereof by utilizing the difference in curing reactivity.

In the present invention, additives may be added to the magnetic layer, if desired. The additives include an abrasive, a lubricant, a dispersant, a dispersion aid, a fungicide, an antistatic agent, an antioxidant, a solvent, a carbon black and the like. Examples of these additives include molybdenum disulfide; tungsten disulfide; graphite; boron nitride; fluorinated graphite; silicone oil; silicone having a polar group; fatty acid-modified silicone; fluorine-containing silicone; fluorine-containing alcohol; fluorine-containing ester; polyolefin; polyglycol; poly-phenyl ether; aromatic ring-containing organic phosphonic acids and alkali metal salts thereof, such as phenyl-phosphonic acid, benzylphosphonic acid, phenethylphosphonic acid, α-methylbenzylphosphonic acid, 1-methyl-1-phenethylphosphonic acid, diphenylmethylphosphonic acids biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid and nonylphenylphosphonic acid; alkylphosphonic acids and alkali metal salts thereof, such as octylphosphonic acid, 2-ethylhexylphosphonic acid, isooctylphosphonic acid, isononylphosphonic acid, isodecylphosphonic acid, isoundecoylphosphonic acid, isododecylphosphonic acid, isohexadecylphosphonic acid, isooctadecylphosphonic acid and isoeicosylphosphonic acid; aromatic phosphoric acid esters and alkali metal salts thereof, such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate and nonylphenyl phosphate; phosphoric acid alkyl esters and alkali metal salts thereof, such as octyl phosphate, 2-ethylhexyl phosphate, isocotyl phosphate, isononyl phosphate, isodecyl phosphate, isoundecyl phosphate, isododecyl phosphate, isobexadecyl phosphate, isooctadecyl phosphate and isoeicosyl phosphate; alkylsulfonic acid esters and alkali metal salts thereof; fluorine-containing alkylsulfuric acid esters and alkali metal salts thereof; monobasic fatty acids having from 10 to 24 carbon atoms, which may contain an unsaturated bond or may be branched, and metal salts thereof, such as lauric acid, myristic acid, palmitic acid, stearic acid, behenic acid, butyl stearate, oleic acid, linoleic acid, linolenic acid, elaidic acid and erucic acid; monofatty acid esters, difatty acid esters and polyfatty acid esters each comprising a monobasic fatty acid having from 10 to 24 carbon atoms, which may contain an unsaturated bond or may be branched, and any one of a mono- to hexa-hydric alcohol having from 2 to 22 carbon atoms, which may contain an unsaturated bond or may be branched, an alkoxy alcohol having from 12 to 22 carbon atoms, which may contain an unsaturated bond or may be branched, and a monoalkyl ether of an alkylene oxide polymerization product, such as butyl stearate, octyl stearate, amyl stearate, isooctyl stearate, octyl myristate, butyl laurate, butoxyethyl stearate, anhydrosorbitan monostearate and anhydrosorbitan tristearate; fatty acid amides having from 2 to 22 carbon atoms; and aliphatic amines having from 8 to 22 carbon atoms. Other than the above-described hydrocarbon groups, those having a nitro group and an alkyl, aryl or aralkyl group substituted by a group except for a hydrocarbon group, such as halogen-containing hydrocarbon (e.g., F, Cl, Br, CF₃, CCl₃, CBr₃) may also be used.

Furthermore, for example, a nonionic surfactant such as alkylene oxide type, glycerin type, glycidol type and alkylphenol ethylene oxide adduct; a cationic surfactant such as cyclic amine, ester amide, quaternary ammonium salts, hydantoin derivative, heterocyclic rings, phosphoniums and sulfoniums; an anionic surfactant containing an acidic group such as carboxylic acid, sulfonic acid or sulfuric acid ester group; and an amphoteric surfactant such as amino acids, aminosulfonic acids, sulfuric acid or phosphoric acid esters of amino-alcohol, and alkylbetaine type, may also be used. These surfactants are described in detail in Kaimen Kasseizai Binran (Handbook of Surfactants), Sangyo Tosho K. K.

These lubricant, antistatic agent and the like need not be necessarily pure and may contain impurities other than the main component, such as isomer, unreacted material, by-product, decomposition product and oxide. The content of these impurities is preferably 30 mass % or less, more preferably 10 mass % or less.

Specific examples thereof these additives include NAA-102, castor hardened fatty acid, NAA-42, Cation SA, Nymeen L-201, Nonion E-208, Anon BF and Anon LG produced by NOF Corporation; FAL-205 and FAL-123 produced by Takemoto Yushi K. K.; NJLub OL produced by New Japan Chemical Co., Ltd.;, TA-3 produced by Shin-Etsu Chemical Industry Co., Ltd.; Armide P produced by Lion Armour Co., Ltd.; Duomine TDO produced by Lion Corp.; BA-41G produced by Nisshin Oil Mills, Ltd.; and Profan 2012E, Newpole PE61 and Ionet MS-400 produced by Sanyo Chemical Industries Ltd.

In the present invention, a carbon black may be added to the magnetic layer, if desired. Examples of the carbon black which can be used in the magnetic layer include furnace black for rubber, thermal black for rubber, black for color, and acetylene black. The carbon black preferably has a specific surface area of 5 to 500 m²/g, a DBP oil absorption of 10 to 400 ml/100 g, a particle diameter of 5 to 300 mμ, a pH of 2 to 10, a moisture content of 0.1 to 10%, and a tap density of 0.1 to 1 g/ml.

Specific examples of the carbon black for use in the present invention include. BLACKPPEARLES 2000, 1300, 1000, 900, 905, 800 and 700, and VULCAN XC-72 produced by Cabot Co., Ltd.;. #80, #60, #55, #50 and #35 produced by Asahi Carbon Co., Ltd.; #2400B, #2300, #900, #1000, #30, #40 and #10B produced by Mitsubishi Chemical Industries, Ltd.; CONDUCTEX SC, RAVEN 150, 50, 40 and 15, and RAVEN-MT-P produced by Columbia Carbon Co., Ltd.; and Ketjen Black EC produced by Nippon EC. The carbon black may be surface-treated with a dispersant or grafted with a resin before use or may be used after graphitizing a part of the surface thereof. Also, the carbon black may be previously dispersed in a binder before addition to the magnetic coating material. These carbon blacks can be used individually or in combination. In the case of using a carbon black, the carbon black is preferably used in an amount of 0.1 to 30 mass % based on the mass of the magnetic power. The carbon black in the magnetic layer has a function of, for example, preventing electrification, reducing the coefficient of friction, imparting light-shielding property or enhancing the film strength, and the function exerted varies depending on the carbon black used. Accordingly, the carbon blacks for use in the present invention can be of course appropriately selected and used according to the purpose by changing the kind, amount and combination thereof among magnetic and nonmagnetic layers based on various properties described above, such as particle size, oil absorption, electric conductivity and pH, and the carbon fiber should be rather optimized in respective layers. The carbon blacks which can be used in the magnetic layer of the present invention are described, for example, in Carbon Black Binran (Handbook of Carbon Blacks), compiled by Carbon Black Kyokai.

The organic solvent for use in the present invention may be a known organic solvent. The organic solvent for use in the present invention may be used at an arbitrary ratio, and examples of the organic solvent which can be used include ketones such as acetone, methyl ethyl ketone, methyl isobutyl ketone, diisobutyl ketonet cyclohexanone, isophorone and tetrahydrofuran; alcohols such as methanol, ethanol, propanol, butanol, isobutyl alcohol, isopropyl alcohol and methylcyclohexanol; esters such as methyl acetate, butyl acetate, isobutyl acetate, isopropyl acetate, ethyl lactate and glycol acetate; glycol ethers such as glycol dimethyl ether, glycol monoethyl ether and dioxane; aromatic hydrocarbons such as benzene, toluene, xylene, cresol and chlorobenzene; chlorinated hydrocarbons such as methylene chloride, ethylene chloride, carbon tetrachloride, chloroform, ethylene chlorohydrin and dichlorobenzene; N,N-dimethylformamide; and hexane.

Such an organic solvent need not be necessarily 100% pure and may contain impurities other than the main component, such as isomer unreacted material, by-product, decomposition product, oxide and water content. The content of these impurities is preferably 30% or less, more preferably 10% or less. The kind of the organic solvent for use in the present invention is preferably the same among magnetic and nonmagnetic layers. The amount added thereof may be varied. It is important that the coating stability is elevated by using a solvent having a high surface tension (such as cyclohexanone or dioxane) for the nonmagnetic layer, more specifically, the arithmetic mean value of the solvent composition for the nonmagnetic layer is higher than the arithmetic mean value of the solvent composition for the upper layer. In order to enhance dispersibility, the polarity is preferably strong to a certain extent, and a solvent having a dielectric constant of 15 or more preferably occupies 50 or more in the solvent composition. The dissolution parameter is desirably from 8 to 11.

The kinds and amounts of these dispersant, lubricant and surfactant for use in the present invention can be selected and used as needed in the magnetic layer and the nonmagnetic layer which is described later. For instance, a dispersant has a property of adsorbing or bonding through a polar group and it is presumed that the dispersant adsorbs or bonds through the above-described polar group mainly to the ferromagnetic powder surface in the magnetic layer and mainly to the nonmagnetic powder surface in the nonmagnetic layer and, for example, the organic phosphorus compound once adsorbed can hardly desorb from the surface of metal, metal compound or the like. Accordingly, the surface of the ferromagnetic powder or nonmagnetic powder of the present invention is in the state of being covered with an alkyl group, an aromatic group or the like, as a result, the affinity of the ferromagnetic metal powder or nonmagnetic powder for the binder resin components is enhanced and the dispersion stability of the ferromagnetic metal powder or nonmagnetic powder is also improved. The lubricant is present in a liberated state and therefore, it may be considered that the bleed-out to the surface is prevented by using fatty acids differing in the melting point among the nonmagnetic and magnetic layers or by using esters differing in the boiling point or polarity, the coating stability is enhanced by controlling the amount of surfactant, or the lubricating effect is elevated by adding the lubricant in a larger amount to the nonmagnetic layer, though the present invention is of course not limited to these examples. The additives for use in the present invention may be added entirely or partially at any step during the preparation of the coating solution for the magnetic or nonmagnetic layer. For example, the additives may be mixed with ferromagnetic powder before the kneading step, may be added at the step of kneading ferromagnetic powder, binder and solvent, may be added at the dispersion step, may be added after the dispersion or may be added immediately before the coating.

[Nonmagnetic Layer]

The details of the nonmagnetic layer are described below. In the magnetic recording medium of the present invention, a nonmagnetic layer comprising a binder and nonmagnetic powder may be provided on the support. The nonmagnetic powder usable in the nonmagnetic layer may be either an organic substance or an inorganic substance. Also, carbon black or the like can be used. Examples of the inorganic substance include metals, metal oxides, metal carbonates, metal sulfates, metal nitrides, metal carbides, and metal sulfides.

More specifically, titanium oxides such as titanium dioxide, cerium oxide, tin oxide, tungsten oxide, ZnO, ZrO₂, SiO₂, Cr₂O₃, α-alumina with an α-conversion ratio of 90 to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, titanium carbide and the like may be used individually or in combination of two-or more. Among these, preferred are α-iron oxide and titanium oxide.

The nonmagnetic powder may be have any shape of needle, sphere, polyhedron and plate. The crystallite size of the nonmagnetic powder is preferably desirably ranges from 4 nm to 1 μm, more preferably from 40 to 100 mm. When the crystallite size is from 4 nm to 1 μm, dispersion is not difficult and a suitable surface roughness is advantageously provided. The average particle diameter of the nonmagnetic powder is preferably from 5 nm to 2 μm, but if desired, the same effect may be brought out by combining nonmagnetic powders differing in the average particle diameter or even when a sole nonmagnetic powder is used by broadening the particle diameter distribution. The average particle diameter of the nonmagnetic powder is more preferably from 10 to 200 run. Within the range of 5 nm to 2 μm, good dispersion and suitable surface roughness are ensured and this is preferred.

The specific surface area of the nonmagnetic powder is from 1 to 100 m²/g, preferably from 5 to 70 m²/g, more preferably from 10 to 65 m²/g. When the specific surface area is in the range of 1 to 100 m²/g, suitable surface roughness is provided and the powder can be advantageously dispersed with a desired amount of binder. The oil absorption using dibutyl phthalate (DBP) is from 5 to 100 ml/100 g, preferably from 10 to 80 ml/100 g, more preferably from 20 to 60 ml/100 g. The specific gravity is from 1 to 12, preferably from 3 to 6. The tap density is from 0.05 to 2 g/ml, preferably from 0.2 to 1.5 g/ml. When the tap density is in the range of 0.05 to 2 g/ml, the particles are less scattered, facilitating the operation, and also the particles tend to less adhere and fix on the apparatus. The pH of the nonmagnetic powder is preferably from 2 to 11, more preferably from 6 to 9. When the pH is in the range of 2 to 11, the coefficient of friction can be prevented from becoming high at high temperature or high humidity or due to liberation of fatty acid. The moisture content of the nonmagnetic powder is from 0.1 to 5 mass %, preferably from 0.2 to 3 mass %, more preferably from 0.3 to 1.5 mass %. When the moisture content is in the range of 0.1 to 5 mass %, good dispersion is ensured and the viscosity of the coating material after dispersion is advantageously stabilized. The ignition loss is preferably 20 mass % or less and a smaller ignition loss is more preferred,

When the nonmagnetic powder is an inorganic powder, the Mohs' hardness is preferably from 4 to 10. When the Mohs' hardness is in the range of 4 to 10, durability can be ensured. The stearic acid adsorption amount of the nonmagnetic powder is from 1 to 20 μmol/m², preferably from 2 to 15 μmol/m². The heat of wetting to water at 25° C. of the nonmagnetic powder is preferably from 200 to 600 erg/cm² (from 200 to 600 mJ/cm²). Also, a solvent having a heat of wetting within this range may be used. The amount of water molecules on the surface at 100 to 400° C. is suitably from 1 to 10 pieces/100 A. The pH at the isoelectric point in water is preferably ranges from 3 to 9. The nonmagnetic powder is preferably surface-treated so that Al₂O₃, SiO₂, TiO₂, ZrO₂, SnO₂, Sb₂O₃ or ZnO can be present on the surface. Among these, preferred in view of dispersibility are Al₂O₃, SiO₂, TiO₂ and ZrO₂, and more preferred are Al₂O₃, SiO₂ and Zro₂. These may be used in combination or individually. According to the purpose, a surface-treatment layer formed by coprecipitation may be used, or a method of treating the surface with alumina and then treating the surface layer with silica or a method reversed thereto may also be employed. The surface-treatment layer may be formed as a porous layer according to the purpose, but in general, the layer is preferably homogeneous and dense.

Specific examples of the nonmagnetic powder for use in the nonmagnetic layer of the present invention include Nanotite produced by Showa Denko K.K.; HIT-100 and ZA-G1 produced by Sumitomo Chemical Co., Ltd.; DPN-250, DPN-250BX, DPN245, DPN-270BX, DPB-550BX and DPN-550RX produced by Toda Kogyo Corp.; TTO-51B, TTO-55A, TTO-55B, TTO-55C, TTO-55S, TTO-55D, SN-100, MJ-7, α-iron oxide E270, E271 and E300 by Ishihara Sangyo Kaisha Ltd.; STT-4D, STT-30D, STT-30 and STT-65C produced by Titan Kogyo K.K.; MT-100S, MT-100T, MT-150W, MT-500B, T-600B, T-100F and T-500HD produced by Teika Co., Ltd.; FINEX-25, BF-1, BF-10, BF-20 and ST-M produced by Sakai Chemical Industry Co., Ltd.; DEFIC-Y and DEFIC-R produced by Dowa Mining Co., Ltd.; AS2BM and TiO2P25 produced by Nippon Aerosil K.K.; 100A and 500A produced by Ube Industries, Ltd.; Y-LOP produced by Titan Kogyo K.K.; and calcined products thereof. As the nonmagnetic powder, titanium dioxide and α-iron oxide are particularly preferred.

In the nonmagnetic layer, carbon black may be mixed together with the nonmagnetic powder so as to reduce the surface electric resistance and the light transmittance and at the same time, obtain a desired micro Vickers hardness. The micro Vickers hardness of the nonmagnetic layer is usually from 25 to 60 Kg/mm² (from 245 to 588 MPa) and for controlling the head abutting, preferably from 30 to 50 Kg/mm² (from 294 to 490 MPa). This hardness can be determined by means of a thin film hardness meter (HMA-400, manufactured by NEC Corp.) using a diamond triangular pyramid needle having a sharpness of 80° and a tip radius of 0.1 μm at the distal end of an indenter. According to the industrial standard for the light transmittance in general, the absorption of infrared ray at a wavelength of about 900 nm is 3% or less and, for example, in the case of a magnetic tape for VHS, this is 0.8% or less. In order to accord with this standard, furnace black for rubber, thermal black for rubber, black for color, acetylene black or the like may be used.

The carbon black for use in the nonmagnetic layer of the present invention has a specific surface area of 100 to 500 m²/g, preferably from 150 to 400 m²/g, and a DBP oil absorption of 20 to 400 ml/100 g, preferably from 30 to 200 ml/100 g. The particle diameter of the carbon black is from 5 to 80 nm, preferably from 10 to 50 nm, more preferably from 10 to 40 nm. Furthermore, the carbon black preferably has a pH of 2 to 10, a moisture content of 0.1 to 10% and a tap density of 0.1 to 1 g/ml.

Specific examples of the carbon black which can be used in the nonmagnetic layer of the present invention include BLACKPEARLES 2000, 1300, 1000, 900, 800, 880 and 700, and VULCAN XC-72 produced by Cabot Co., Ltd.; #3050B, #3150B, #3250B, #3750B, #3950B, #950, #650S, #970B, #850B and MA-600 produced by Mitsubishi Chemical Industries, Ltd.; CONDUCTEX SC, RAVEN 8800, 8000, 7000, 5750, 5250, 3500, 2100, 2000, 1800, 1500, 1255 and 1250 produced by Columbia Carbon Co., Ltd.; and Ketjen Black EC produced by Akzo Co., Ltd.

The carbon black may be surface-treated with a dispersant or grafted with a resin before use or may be used after graphitizing a part of the surface thereof. The carbon black may be previously dispersed in a binder before the addition to the coating material. The carbon black can be used within the range of not exceeding 50 mass % based on the above-described inorganic powder and not exceeding 40% of the total mass of the nonmagnetic layer. These carbon blacks can be used individually or in combination. The carbon blacks which can be used in the nonmagnetic layer of the present invention are described, for example, in Carbon Black Binran (Handbook of Carbon Blacks), compiled by Carbon Black Kyokai.

In the nonmagnetic layer, an organic powder may also be added according to the purpose. Examples of the organic powder include acryl styrene-based resin powder, benzoguanamine resin powder, melamine-based resin powder and phthalocyanine-based pigment. In addition, polyolefin-based resin powder, polyester-based resin powder, polyamide-based resin powder, polyimide-based resin powder and polyethylene fluoride resin may also be used. As for the production method thereof those is disclosed in JP-A-62-18564 and JP-A-60-255827 can be used.

With respect to the binder resin, lubricant, dispersant, additive, solvent, dispersing method and others of the magnetic layer, those described for the magnetic layer can be applied. In particular, as for the amounts and kinds of the binder resin, additive and dispersant, known techniques regarding the magnetic layer can be applied.

In the magnetic recording medium of the present invention, an undercoat layer may be provided. By providing an undercoat layer, the adhesive strength between the support and the magnetic or nonmagnetic layer can be enhanced. For the undercoat layer, a polyester resin soluble in a solvent is used.

[Layer Structure]

As for the thickness constitution of the magnetic recording medium of the present invention, the thickness of the support is preferably from 3 to 80 μm. When an undercoat layer is provided between the support and the magnetic or nonmagnetic layer, the thickness of the undercoat layer is from 0.01 to 0.8 μm, preferably from 0.02 to 0.6 μm.

The thickness of the magnetic layer is optimized according to the saturation magnetization amount of the magnetic head used, the head gap length and the recording signal band, but the thickness is generally from 10 to 150 nm, preferably from 20 to 80 nm, more preferably from 30 to 80 nm. The thickness fluctuation ratio of the magnetic layer is preferably within ±50%, more preferably within ±40%. It is sufficient if at least one magnetic layer is formed, but the magnetic layer may be separated into two or more layers having different magnetic properties, and known constitutions for multilayer magnetic layer may be applied.

The thickness of the nonmagnetic layer of the present invention is from 0.5 to 2.0 μm, preferably from 0.8 to 1.5 μm, more preferably from 0.8 to 1.2 μm. In the magnetic recording medium of the present invention, the nonmagnetic layer can exert its effects if it is substantially nonmagnetic. For example, even when a small amount of a magnetic material is intentionally incorporated as an impurity, the effect of the present invention is exhibited and this constitution can be regarded as essentially identical to the magnetic recording medium of the present invention. The term “essentially identical” as used herein means that the residual magnetic flux density of the nonmagnetic layer is 10 mT or less or the coercive force is 7.96 kA/m (100 Oe) or less, preferably that the nonmagnetic layer has neither a residual magnetic flux density nor a coercive force.

[Production Method]

The process of producing the coating solution for the magnetic layer of the magnetic recording medium of the present invention comprises at least a kneading step, a dispersion step, and mixing steps provided, if desired, before and after these steps. Each step may be divided into two or more stages. The raw materials used in the present invention, such as ferromagnetic metal powder, nonmagnetic powder, binder, carbon black, abrasive, antistatic agent, lubricant and solvent, all may be added at the beginning or on the way of any step. Furthermore, each raw material may be added in parts at two or more steps. For example, polyurethane may be added in parts at the kneading step, dispersion step and mixing step for adjusting the viscosity after the dispersion. In order to achieve the object of the present invention, conventionally known production techniques may be employed for some steps. In the kneading step, a kneading device having high kneading strength, such as open kneader, continuous kneader, pressure kneader and extruder, is preferably used. In the case of using a kneader, the magnetic powder or nonmagnetic powder and the whole or a part (preferably 30% or more of the entire binder) of the binder in a range of 15 to 500 parts by mass per 100 parts by mass of the magnetic material are kneaded. The details of the kneading process are described in JP-A-1-106338 and JP-A-1-79274. For dispersing the solution for magnetic or nonmagnetic layer, glass beads may be used. The glass bead is preferably zirconia bead, titania bead or steel bead which are a dispersion medium with high specific gravity. Such a dispersion medium is used after optimizing the particle diameter and the filling ratio. As for the dispersing machine, a known dispersing machine can be used.

In the production method for the magnetic recording medium of the present invention, the magnetic layer is formed, for example, by coating a magnetic coating solution on the surface of a nonmagnetic support under running to a predetermined film thickness. A plurality of coating solutions for magnetic layer may be sequentially or simultaneously coated one on another or the coating solution for nonmagnetic layer and the coating solution for magnetic layer may be sequentially or simultaneously coated one on another. In coating the magnetic coating solution or the coating solution for nonmagnetic layer, a coating machine such as air doctor coat, blade coat, rod coat, extrusion coat, air knife coat, squeeze coat, impregnation coat, reverse roll coat, transfer roll coat, gravure coat, kiss coat, cast coat, spray coat and spin coat can be used. These are described, for example, in Saishin Coating Gijutsu (Latest Coating Technology), issued by Sogo Gijutsu Center (May 31, 1983).

In the case of a magnetic tape, the coating layer formed from the coating solution for magnetic layer is subjected to a treatment of applying longitudinal magnetic orientation to the ferromagnetic metal powder contained in the coating layer formed from the coating solution for magnetic layer, by using a cobalt magnet or a solenoid. In the case of a disc, sufficiently isotropic orientation may be obtained even without performing orientation using an orientation apparatus, but a known random orientation apparatus is preferably used, where, for example, cobalt magnets are diagonally and alternately disposed or an AC magnetic field is applied by a solenoid. As for the isotropic orientation, in the case of a ferromagnetic metal powder, in-plane two-dimensional random orientation is generally preferred but three-dimensional random orientation may also be generated by incorporating a vertical component. In the case of hexagonal ferrite, in-plane three-dimensional random orientation in the vertical direction is generally liable to be generated, but in-plane two-dimensional random orientation can also be generated. Furthermore, vertical orientation may be generated by using a known method such as different pole and counter position magnet, so that isotropic magnetic properties in the circumferential direction can be imparted. Particularly, in the case of performing high-density recording, vertical orientation is preferred. Also, spin coat may be employed to generate circumferential orientation.

The drying position of the coating film is preferably controlled by controlling the temperature and flow rate of drying air and the coating rate. The coating rate is preferably from 20 to 1,000 m/min, and the temperature of drying air is preferably 60° C. or more. Also, pre-drying may be appropriately performed before the coating film enters the magnet zone.

The coated layer after drying is subjected to a surface smoothing treatment. In the surface smoothing treatment, for example, a supercalender roll or the like is utilized. When a surface smoothing treatment is performed, pores produced after removal of the solvent at the drying are eliminated and the filling ratio of the ferromagnetic metal powder in the magnetic layer is elevated, so that a magnetic recording medium with high electromagnetic conversion property can be obtained. As for the calendering roll, a heat-resistant plastic roll such as epoxy, polyimide, polyamide and polyamidoimide is used. The treatment may also be performed with a metal roll.

The magnetic recording medium of the present invention preferably has a remarkably excellent surface smoothness such that the center surface average roughness at a cutoff value of 0.25 mm is from 0.1 to 4 nm, preferably from 1 to 3 nm. This is achieved, for example, by a method where the magnetic layer formed by selecting a specific ferromagnetic metal powder and binder as described above is subjected to the above-described calendering. As for the calendering conditions, the calendering roll temperature is from 60 to 100® C., preferably from 70 to 100° C., more preferably from 80 to 100° C., and the pressure is from 100 to 500 kg/cm (from 98 to 490 kN/m), preferably from 200 to 450 kg/cm (from 196 to 441 kN/m), more preferably from 300 to 400 kg/cm (from 294 to 392 kN/m).

In the present invention, the shrinkage percentage of the magnetic recording medium after storage for 1 week under the conditions of 70° C. and 5% RH must be 0.040% or less. As for the means of reducing the thermal shrinkage percentage, for example, a method of heat-treating (for example, at 100 to 150° C.) the support, coated medium or calendered medium in a web state while handling at a low tension may be employed.

The magnetic recording medium obtained can be used by cutting it into a desired size with use of a cutter or the like. The cutter is not particularly limited but is preferably a cutter where a plurality of pairs of rotating upper blade (male blade) and lower blade (female blade) are provided. The slitting rate, the depth of engaging, the ratio of circumferential velocity between upper blade (male blade) and lower blade (female blade) (circumferential velocity of upper blade/circumferential velocity of lower blade), and the continuous working time of slitting blade are appropriately selected

[Physical Properties]

In the magnetic recording medium of the present invention, the saturated magnetic flux density of the magnetic layer is preferably from 100 to 300 mT, and the coercive force (Hc) of the magnetic layer is preferably from 143.3 to 318.4 kA/m (from 1,800 to 4,000 Oe), more preferably from 159.2 to 278.6 kA/m (from 2,000 to 3,500 Oe). The distribution of the coercive force is preferably narrower, and SFD and SFDr are preferably 0.6 or less, more preferably 0.2 or less.

In the magnetic recording medium of the present invention, the coefficient of friction against a head is 0.5 or less, preferably 0.3 or less, at a temperature of −10 to 40° C. and a humidity of 0 to 95%. The surface resistivity is preferably from 10⁴ to 10¹² Ω/sq on the magnetic surface, and the electrification potential is preferably from −500 V to +500 V. The elastic modulus at 0.5% elongation of the magnetic layer is preferably from 0.98 to 19.6 GPa (from 100 to 2,000 kg/mm²) in any in-plane direction, and the breaking strength is preferably from 98 to 686 MPa (from 10 to 70 kg/mm²). The elastic modulus of the magnetic recording medium is preferably from 0.98 to 14.7 GPa (from 100 to 1,500 kg/mm²) in any in-plane direction, the residual elongation is preferably 0.5% or less, and the thermal shrinkage percentage at any temperature of 100° C. or less is preferably 1% or less, more preferably 0.5% or less, and most preferably 0.1% or less.

The glass transition temperature (the maximum point of the loss elastic modulus in the measurement of dynamic viscoelasticity measured at 110 Hz) of the magnetic layer is preferably from 50 to 180° C., and the glass transition point of the nonmagnetic layer is preferably from 0 to 180° C. The loss elastic modulus is preferably from 1×10⁷ to 8×10⁸ Pa (from 1×10⁸ to 8×10⁹ dyne/cm²), and the loss tangent is preferably 0.2 or less. If the loss tangent is too large, adhesion failure is liable to occur. These thermal and mechanical properties are preferably almost equal in any in-plane direction of the medium with a tolerance of 10% or less.

The amount of the residual solvent contained in the magnetic layer is preferably 100 mg/m² or less, more preferably 10 mg/m² or less. The void ratio of the coated layer is preferably 30 vol % or less, more preferably 20 vol % by volume or less, in both the nonmagnetic layer and the magnetic layer. The void ratio is preferably smaller for obtaining high output but depending on the purpose, it is sometimes preferred to assure a certain value for the void ratio. For example, in the case of a disc medium which places importance on the repeated use, good running durability is obtained with a larger void ratio in many cases.

The magnetic layer preferably has a maximum height SRₘₐₓ of 0.5 μm or less, a ten-point average roughness SRz of 0.3 μm or less, a center plane peak height SRp of 0.3 μm or less, a center plane valley depth SRv of 0.3 μm or less, a center plane area ratio SSr of 20 to 80%, and an average wavelength Sλa of 5 to 300 μm. These factors can be easily controlled by controlling the surface property of the support with a filler, or by selecting the roll surface shape in the calender treatment. The curl is preferably controlled to be within ±3 mm.

When the magnetic recording medium of the present invention comprises a nonmagnetic layer and a magnetic layer, these physical properties can be varied between the nonmagnetic layer and the magnetic layer according to the purpose. For example, the elastic modulus of the magnetic layer may be made higher to enhance the running durability, while setting the elastic modulus of the nonmagnetic layer to be lower than that of the magnetic layer to allow for good abutting of the magnetic recording medium against a head.

### EXAMPLES

The present invention is described in greater detail below by referring to Examples and Comparative Examples. In Examples, the “parts” is on the mass basis.

<Preparation of Coating Material>

Magnetic Coating Material

| | | |
|---|---|---|
| Barium ferrite magnetic powder | 100 | parts |
| Composition by molar ratio to Ba: | | |
| Fe 9.10, Co 0.22, Zn 0.71 | | |
| Hc: 2,400 Oe (192 kA/m | | |
| S_{BET}: 70 m²/g, σs: 52 Am²/kg | | |
| Average plate diameter: 22 nm, | | |
| average plate ratio: 3.0 | | |
| Polyurethane resin | 10 | parts |
| Diamond | 3 | parts |
| MD150 (produced, by Tomei Dia) | | |
| Carbon black | 1 | part |
| #50 (produced by Asahi Carbon Co., | | |
| Ltd.) | | |
| Oleic acid | 1 | part |
| Stearic acid | 1 | part |
| Methyl ethyl ketone | 125 | parts |
| Cyclohexanone | 125 | parts |

Nonmagnetic Coating Material:

| | | |
|---|---|---|
| Nonmagnetic powder, α-Fe₂O₃ hematite | 80 | parts |
| average major axis length: 0.08 | | |
| μm, S_{BET}: 60 m²/g | | |
| pH: 9 | | |
| surface-treatment layer: Al₂O₃ is | | |
| present on the surface at a | | |
| proportion 8 mass % based on all | | |
| particles | | |
| Carbon black | 15 | parts |
| CONDUCTEX SC-U (produced by | | |
| Columbia Carbon Co., Ltd.) | | |
| Polyurethane resin | 12 | parts |
| UR8200 (produced by Toyobo Co., | | |
| Ltd.) | | |
| Oleic acid | 2 | parts |
| Stearic acid | 2 | parts |
| Phenylphosphonic acid | 5 | parts |
| Methyl ethyl ketone/cyclohexanone (a 8/2 | 250 | parts |
| mixed solvent) | | |

<Production of Magnetic Disc Medium>

The components for each coating solution above were kneaded and then dispersed by using a sand mill. Thereafter, a polyisocyanate-based hardening agent was added to the obtained liquid dispersions, in an amount of 6 parts for the coating solution for nonmagnetic layer, and 3 parts for the coating solution for magnetic layer. After further adding 40 parts of cyclohexanone to each dispersion, the liquid dispersions each was filtered through a filter having an average pore diameter of 1 μm to obtain coating solutions for forming a nonmagnetic layer and for forming a magnetic layer.

The obtained coating solution for nonmagnetic layer was coated on a support to have a dry thickness of 1.2 μm and once dried and thereafter, the coating solution for magnetic layer was immediately dried by a blade method to form a magnetic layer having a predetermined thickness (0.1 μm) and dried. The support with these coated layers was treated by a 7-stage calender at 90° C. under a linear pressure of 300 kg/cm (294 kN/m) and then punched into a disc having a diameter of 1.8 inches, and the disc was subjected to thermo-processing at 55° C. to accelerate the curing of the coated layers. In this way, samples of the present invention and comparative samples were produced.

Incidentally, polyester supports shown in Table 1 produced by changing the stretching conditions and heat treatment conditions were used as the support.

The samples obtained were then subjected to the following measurements

Measurement of Curl:

The magnetic disc was erected upright by fixing its center position, and the displacement in the horizontal direction at the position, of 22 mm from the center position was measured for one round portion of the magnetic disc by a laser displacement meter (LK-031, manufactured by Keyence). The maximum value of the obtained absolute values was defined as the curl amount.

Measurement of Thermal Shrinkage Percentage:

The dimensions of the magnetic disc before and after storage for 1 week at 70° C. and 5% RH were measured by a measuring microscope (MN-60/L3, manufactured by NIKON) at 23° C. and 45% RH, and the rate of change therebetween was defined as the thermal shrinkage percentage.

Envelope Waveform:

The magnetic disc was rotated at 3,000 rpm and recording/reproduction was performed to give a recording density of 180 KFCI at the position of 18 mm from the center by a composite AMR head with a writing track width of 1.5 μm, a gap length of 0.3 μm and a reading track width of 0.9 μm. The envelope reproducing waveform was observed by an oscilloscope, and the disorder of waveform due to head abutting failure was evaluated as follows.
X : Serious disorder of waveform was observed.
Δ: Disorder of waveform was observed.
◯Δ: Disorder of waveform was sometimes observed.
◯: Disorder of waveform was not observed.
   Evaluation of Crystal Moiety by ATR-FT-IR:

With respect to the polyester support used for the production of the magnetic recording medium, the crystal moiety was evaluated by the ATR-FT-IR method.

The spectrum in the machine direction (MD) and the transverse direction (TD) at the production of the support was measured on front and back surfaces of the support by using Nexus 670 (trade name, manufactured by Thermo-Nicolet) with a once-reflection accessory (Ge, incident angle: 45°) at a resolution of 1 cm⁻¹ through integration of 200 times on the same portion.

In the case of polyethylene naphthalate (PEN) the absorbance of γω (CH₂) gauche peak at 1,370 cm⁻¹ was determined, and the absorbance of γω (CH₂) trans peak at 1,337 cm⁻¹ was further determined. From the measured values, the gauche/tans peak intensity ratio was determined and used as an index for the degree of crystallization.

In the case of polyethylene terephthalate (PET), the absorbance of γω (CH₂) gauche peak at 1,365 cm⁻¹ was determined, and the absorbance of γω (CH₂) trans peak at 1,337 cm⁻¹ was further determined. From the measured values, the gauche/tans peak intensity ratio was determined and used as an index for the degree of crystallization.

Incidentally, the gauche/trans peak intensity ratio is a peak intensity ratio in the- MD and TD directions on the front and back surfaces of the polyester support.

The results are shown in Table 1.

TABLE 1
Evaluation Results

| | | Kind of | Thermal | | | Gauoho/ | |
|---|---|---|---|---|---|---|---|
| | | Poly- | Shrinkage | | | Trans Peak | |
| Medium | | ester | Percentage | Curl | Envelope | Intensity | Overall |
| No. | Remarks | Support | (%) | (mm) | Waveform | Ratio | Rating |
| 1 | Comparative | PET | 0.048 | 0.08 | ◯ | 0.05 | X |
| | Example | | | | | | |
| 2 | Comparative | PEN | 0.021 | 0.53 | X | 0.56 | X |
| | Example | | | | | | |
| 3 | Comparative | PEN | 0.032 | 1.21 | X | 0.59 | X |
| | Example | | | | | | |
| 4 | Example | PEN | 0.016 | 0.38 | ◯Δ | 0.48 | ◯Δ |
| 5 | Example | PEN | 0.020 | 0.11 | ◯ | 0.31 | ◯ |
| 6 | Example | PEN | 0.019 | 0.21 | ◯ | 0.40 | ◯ |
| 7 | Example | PET | 0.035 | 0.03 | ◯ | 0.04 | ◯ |

As seen in Table 1, Examples of the present invention have more excellent properties than ever before, with less disorder of envelope waveform and no dimensional change due to storage.

This application is based on Japanese Patent application JP 2004-148754, filed May 19, 2004, the entire content of which is hereby incorporated by reference, the same as if set forth at length.

1. A magnetic recording medium comprising: a nonmagnetic support; and a magnetic layer containing ferromagnetic powder and a binder, wherein the nonmagnetic support contains polyester, the nonmagnetic support has gauche/trans peak intensity ratio of 0.50 or less as determined by a ATR-FT-IR method, and a shrinkage percentage of the magnetic recording medium after storage for 1 week under a conditions of 70° C. and 5% RH is 0.040% or less.

2. The magnetic recording medium according to claim 1, further comprising a substantially nonmagnetic lower layer between the magnetic layer and the nonmagnetic support.

3. The magnetic recording medium according to claim 2, wherein the substantially nonmagnetic lower layer contains a binder and nonmagnetic powder.

4. The magnetic recording medium according to claim 1, wherein the nonmagnetic support contains polyethylene naphthalate.

5. The magnetic recording medium according to claim 2, wherein the nonmagnetic support contains polyethylene naphthalate.

6. The magnetic recording medium according to claim 1, wherein the nonmagnetic support further contains a filler.

7. The magnetic recording medium according to claim 1, wherein the nonmagnetic support has a thickness of from 10 to 100 μm.

8. The magnetic recording medium according to claim 1, wherein the nonmagnetic support has a thickness of from 20 to 80 μm.

9. The magnetic recording medium according to claim 1, wherein the nonmagnetic support has a central line average surface roughness of 8 nm or less.

10. The magnetic recording medium according to claim 1, wherein the nonmagnetic support has a central line average surface roughness of 6 nm or less.
